(19) United States
(12) Patent Application Publication
(10) Pub. No.: US 2013/0339369 A1
(43) Pub. Date: Dec. 19, 2013

(54) Search Method and Apparatus

(71) Applicant: Alibaba Group Holding Limited, Grand Cayman (KY)

(72) Inventors: Yaobing Li, Hangzhou (CN); Wei Zheng, Hangzhou (CN); Huaxing Jin, Hangzhou (CN); Feng Lin, Hangzhou (CN)

(21) Appl. No.: 13/919,657

(22) Filed: Jun. 17, 2013

(30) Foreign Application Priority Data
Jun. 19, 2012 (CN) 201210208671.8

(51) Int. Cl. G06F 17/30

(52) U.S. Cl. CPC G06F 17/30622
USPC 707/742

(57) ABSTRACT

The present disclosure provides techniques to solve problems (e.g., the low efficiency and a waste of resources) derived from conventional methods. These techniques may include extracting, by a computing device, the first N keywords appearing the most in target information published by target users as target words, and creating an inverted index based on information on a page of the target users and the target words, wherein the inverted index includes a target field and a page information field, and N is an integer. The computing device may receive an inquiry phrase and determine target users matching the inquiry phrase in the inverted index based on the inquiry phrase. The computing device may calculate a relevance between the matched target users and the inquiry phrase through the target field and the page information field, and return a certain result based on the relevance.

### CROSS REFERENCE TO RELATED PATENT APPLICATIONS

This application claims priority to Chinese Patent Application No. 201210208671.8, filed on Jun. 19, 2012, entitled “Search Method and Apparatus,” which is hereby incorporated by reference in its entirety.

### TECHNICAL FIELD

The present disclosure relates to search technology and, more specifically, to a search method and a search device.

### BACKGROUND

With the development of the Internet, more and more users publish and obtain information via the Internet. Therefore, there is a need to obtain information of publishers on a platform (i.e., searching target users).

Generally, an index is created while the information of target users on the platform is searched. As such, after a visitor submits a query including a phrase, the platform server may find certain target users matching the phrase, and return results to the visitor.

However, the information on target users' pages sometime includes only brief introductions of the target users, and cannot represent them as a whole. Therefore, using the above-mentioned method, returned results are not representative, and call-back rates are lower. In addition, the information on target users' pages may not be updated frequently, and thus the information is old. Therefore, the accuracy of search results based on the aforementioned method is low.

To solve the problem, a platform server may collect the information published by target users on the platform to create an information database. The server conducts searches and sorts the information in the information database based on feedback. However, the size of the information database is huge since the platform may have many target users and each target user may publish a great amount of information.

In addition, the information published by each target user may be complicated. For example, certain information is often published by the target user while other information is published occasionally. The information occasionally published is usually ranked in low places, and means less, sometimes even nothing, to visitors. For example, for an e-commerce platform, a visitor desires to search main products of a supplier that matches a query phrase, while avoiding products that are sold merely once or twice by the suppliers.

When target users are searched against a query on a platform, the matching process is generally conducted using large amounts of data that are obtained from information databases. Not surprisingly, search efficiency is low. The information occasionally published is also searched and meaningless data is obtained. This causes a waste of resources.

### SUMMARY

Therefore, the present disclosure provides a search method and a search device to solve the problem of the low efficiency and the waste of resources associated with conventional search methods.

To solve the above problems, embodiments of the present disclosure relate to a method. The method includes extracting, by a server, the first N headwords (e.g., keywords) appearing the most in target information published by target users. The first N headwords are saved as target words. The server may create an inverted index based on information on a page of the target users and the target words, wherein the inverted index includes a target field and a page information field, and N is an integer.

The server may also receive an inquiry phrase, and then find target users matching the inquiry phrase in the inverted index based on the inquiry phrase. The server may determine a relevance between the matched target users and the inquiry phrase through the target field and the page information field, and sorting the target users based on the relevance and returning.

In some embodiments, the operation of extracting the first N headwords appearing most in target information published by target users as target words may include obtaining target word databases from the target information published by target users, extracting headwords from the target word databases based on preset conditions, calculating times of appearance of the headwords of all target word databases published by the target users, and obtaining the first N headwords appearing the most as the target words.

In some embodiments, for each headword, the server may calculate a ratio between the times of appearances of the headword and the times of appearances of all headwords, and make the ratio as a target factor of the headword.

In some embodiments, the operation of determining relevance between the matched target users and the inquiry phrase through the target field and the page information field may include, for the matched target users, determining a match level of the target field and the page information field with the inquiry phrase, making a weighted summation of all match levels, and using a result as the relevance between the matched target users and the inquiry phrase.

In some embodiments, the server may make suppliers as the target users, and then make product information as the target information as well as main product words as the target words.

In some embodiments, the target word information may include product titles, and the operation of extracting the first N headwords appearing the most in target information published by target users as target words may include obtaining product titles from the product information published by suppliers, extracting headwords from the product titles based on preset grammatical rules, calculating times of appearance of the headwords of all the product titles published by the publishers, and obtaining the first N headwords appearing the most as the main product words.

In some embodiments, for each headword, the server may calculate a ratio between the times of appearances of the headword and the times of appearances of all headwords, and make the ratio as a main product factor of the headword.

In some embodiments, the target field is the main product field. In these instances, the operation of determining a relevance between the matched target users and the inquiry phrase through the target field and the page information field may include, for the matched suppliers, determining a match level of the main product field and the page information field with the inquiry phrase in terms of word level, determining a match level of the main product field and the page information field with the inquiry phrase in terms of semantic level, making a weighted summation of all match levels, and using a result as the relevance between the matched suppliers and the inquiry phrase.

In some embodiments, the server may pre-process the inquiry phrase before the operation of determining a relevance between the matched target users and the inquiry phrase through the target field and the page information field. The pre-processing may include at least one of deleting invalid characters of the inquiry phrase, extracting headwords from the inquiry phrase based on preset grammatical rules; deleting a word root of the inquiry phrase, and/or identifying national geography information of the inquiry phrase.

In some embodiments, the server may pre-process information on a page of the suppliers before the operation of creating an inverted index based on information on a page of the target users and the target words. In these instances, the server may pre-process information by deleting invalid characters of information on the page, and/or deleting a word root of information on the page.

In some embodiments, the server may extract the page information field from the preprocessed page. The page information field may include at least one of a main product field, a nation field, a company address field and/or a company name field.

In some embodiments, the operation of determining a match level of the main product field and the page information field with the inquiry phrase in terms of word level may include calculating a corresponding match level when the page information field is determined to match the inquiry phrase in terms of word level, and calculating a corresponding match level through the main product factor when the main product field is determined to match the inquiry phrase in terms of word level.

In some embodiments, the operation of determining a match level of the main product field and the page information field with the inquiry phrase in terms of semantic level may include calculating a corresponding match level when the page information field is determined to match headwords of the inquiry phrase in terms of semantic level, and calculating a corresponding match level through the main product factor when the main product field is determined to match headwords of the inquiry phrase in terms of semantic level.

Embodiments of the present disclosure also relate to a device. The device may include an obtaining and creating module configured to extract the first N headwords appearing the most in target information published by target users as target words, and to create an inverted index based on information on a page of the target users and the target words, wherein the inverted index includes a target field and a page information field, and N is an integer. The device may include a receiving module configured to receive an inquiry phrase. The device may include a finding module configured to find target users matching the inquiry phrase in the inverted index based on the inquiry phrase. The device may include a sorting module configured to determine a relevance between the matched target users and the inquiry phrase through the target field and the page information field, and to sort the target users based on the relevance and returning.

Compared with conventional techniques, the present disclosure has advantages. First, in the conventional techniques, searching based on a query phrase using a large amount of data results in the low search efficiency. In addition, meaningless data is obtained in the finding and search processes, therefore causing a waste of resources. However, the present disclosure extracts headwords from target information published by target users, and makes first N headwords appearing the most as target words before searching. Thus, the information frequently published by the target users is obtained. Pre-processing the information published by users may reduce meaningless data. Embodiments of this disclosure create an inverted index based on information on a page of the target users and the target words. Then, after receiving the query phrase, the server finds target users matching the inquiry phrase in the inverted index based on the inquiry phrase. Thus, there is no need to find or match the meaningless data during the search process. The server sorts and returns results after determining a relevance between the matched target users and the inquiry phrase. Accordingly, techniques of the present disclosure increase the search efficiency and reduce the waste of resources.

In addition, the present disclosure may be applied to the e-commerce industry by making suppliers as the target users, making product information as the target information, and making main product words as the target words. Not only may the information be obtained from the suppliers' pages, but also the main product words may be obtained from the product information published by suppliers. The product information published by suppliers may thoroughly cover suppliers' product and may be timely updated. Therefore, the present disclosure obtains the main product words from the product information published by suppliers and reduces the meaningless product information of target users, and the search accuracy based on the relevance of the main products is higher than those under the conventional techniques described above. As such, while providing accurate and thorough search results, embodiments of this disclosure maintain high search efficiency and avoid a waste of resources.

Furthermore, embodiments of the present disclosure may pre-process the information of pages and the query phrase by deleting invalid characters, and/or word roots. Embodiments of the present disclosure may speed up searches, determine the sorting processes, and return accurate and relevant results.

### BRIEF DESCRIPTION OF THE DRAWINGS

The Detailed Description is described with reference to the accompanying figures. The use of the same reference numbers in different figures indicates similar or identical items.

FIG. 1 is an exemplary process for searching.

FIG. 2 is another exemplary process for obtaining main product words.

FIG. 3 is yet another exemplary process for determining a relevance.

FIG. 4 is a diagram of a search device.

### DETAILED DESCRIPTION

To make the objects, features and advantages of the present disclosure more clear, a detailed description is given in conjunction with the FIGS and embodiments.

Under conventional techniques, a search for determining target users is performed based on a match between a huge information database and an inquiry phrase. Therefore, the search efficiency associated with these techniques is low and a waste of resources is inevitable.

Embodiments of the present disclosure not only obtain information from the pages of target users, but also extracts the first N headwords (e.g., keywords) appearing most in target information published by target users as target words. Therefore, there is no need to find or match meaningless data during the search process. This increases the search efficiency and reduces the waste of resource.

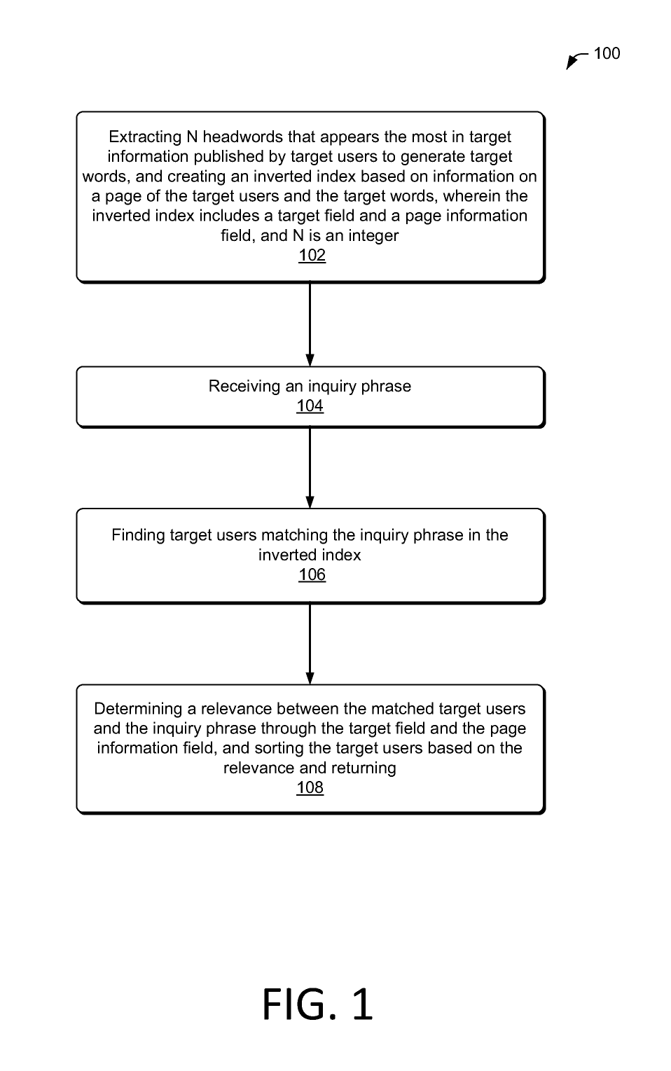

FIG. 1 is an exemplary process for searching. At 102, a server may extract the first N headwords appearing the most in target information published by target users as target words, and create an inverted index based on information on a page of the target users and the target words, wherein the inverted index may include a target field and a page information field, and N is an integer.

The target user may be a user using a platform, and specific target users are determined based on the nature of the platform. For example, for the platform “weibo”, the weibo users are the target users; for the e-commerce platform, the sellers and the buyers are the target users.

On a platform, page information of target users may include a brief introduction of the target users. The introduction may include the relevant information of the target users. Similarly, the target users may publish target information on the platform. Therefore, headwords may be obtained from the target information published by the target users, and the first N headwords appearing the most among all headwords are obtained as the target words. The headwords may be the words presenting a key feature of the target information. For example, on an e-commerce platform, product titles published by the seller are the target information, and headwords of the target information are the products of the product titles. For instance, if the product title is “a classic dress popular in Europe and America”, the headword is “dress”.

In addition, information published by each target user may be complicated. For example, certain information is frequently published by the target user while other information is occasionally published. The information occasionally published is usually given a low ranking, and means less, sometimes even nothing, to the visitor. For example, for an e-commerce platform, a visitor desires to search main products of a supplier based on a query to find relevant products that are sold frequently but not ones sold by the suppliers occasionally.

Under conventional search techniques, searches are performed based on a phrase using a large amount of data obtained from information databases, and thus its search efficiency is low. In addition, the information occasionally published is also searched. This causes a waste of resources.

Embodiments of the present disclosure extract headwords from target information published by target users, and make first N headwords appearing the most as target words before searches are performed. The information frequently published by the target users is obtained. Pre-processing the information published by users may reduce meaningless data. Therefore, the meaningless data is not searched, thus increasing the search efficiency and reducing a waste of resources.

In some embodiments, for each target user, an inverted index is created based on information on a page of the target users and the target words. An exemplary inverted index is shown in Table 1.

TABLE 1

| User ID | Target Field | Page Information Field |
|---|---|---|
| 00001 | XXXXX | XXXXX |
| . . . | . . . | . . . |

As illustrated in Table 1, a user ID (identity) is used to identify a target user, a field value of a target field corresponds to a target word of a target user, and the field value of a page information field corresponds to information on the page of the target user. Of course, the inverted index may comprise different data, and the present disclosure does not intend to limit it.

In some embodiments, the operation of extracting the first N headwords appearing the most in target information published by target users as target words may include obtaining target word databases from the target information published by target users, extracting headwords from the target word databases based on preset conditions, calculating times of appearance of the headwords of all target word databases published by the target users, and obtaining the first N headwords appearing most as the target words.

In some embodiments, for each headword, the server may calculate a ratio between the times of appearances of the headword and the times of appearances of all headwords. The server may then save the ratio as a target factor of the headword.

At 104, the server may receive a query including a phrase (e.g., an inquiry phrase). In the search process, users may input the inquiry phrase and click “search”. As such an inquiry phrase may be received. At 106, the server may find target users matching the inquiry phrase in the inverted index.

A finding process may be conducted in the inverted index based on the inquiry phrase to see whether the inquiry phrase matches target values of a target field and a page information field. If so, the users corresponding to the matched field value are determined as the target users.

At 108, the server may determine a relevance between the matched target users and the inquiry phrase through the target field and the page information field, and sort the target users based on the relevance and returning. Further, the server may calculate a relevance between the matched target users and the inquiry phrase through the target field and the page information field, sort the target users in a descending order based on the relevance, and return the sorted data back to the users conducing the search.

In some embodiments, the operation of determining a relevance between the matched target users and the inquiry phrase through the target field and the page information field may include determining a match level of the target field and the page information field with the inquiry phrase for the matched target users, making a weighted summation of all match levels, and using a result as the relevance between the matched target users and the inquiry phrase.

In conventional techniques, searches are performed based on an inquiry phrase using a large amount of data, resulting in a low search efficiency. In addition, meaningless data is obtained during the searches, therefore causing a waste of resources. However, embodiments of the present disclosure extract headwords from target information published by target users, and make first N headwords appearing the most as target words before searching. The information frequently published by the target users is obtained. Pre-processing the information published by users may reduce the meaningless data. In some instances, the server may create an inverted index based on information on a page of the target users and the target words. Later, after receiving the inquiry phrase, the server may find the target users matching the inquiry phrase in the inverted index. Thus, it does not need to find or match the meaningless data during the search process. After determining a relevance between the matched target users and the inquiry phrase, the server may sort and return results. The present disclosure therefore increases the search efficiency and reduces the waste of resources.

Embodiments of the present disclosure may be applied to the e-commerce industry. If suppliers are the target users, information on the pages of suppliers may be obtained. The information may include business content, main products, and company sizes provided by the suppliers. Suppliers may further publish product information including titles, model numbers, and prices of products. For example, for a supplier, the business content is an electronic product, and main products are MP3 players, MP4 players, mobile phones, etc. The product information published by the supplier contains MP3 XX1, MP3 XX2, and MP4 SS1, as well as corresponding specific model numbers and prices.

Therefore, the present disclosure may make suppliers as the target users, make product information as the target information, and make main product words as the target words.

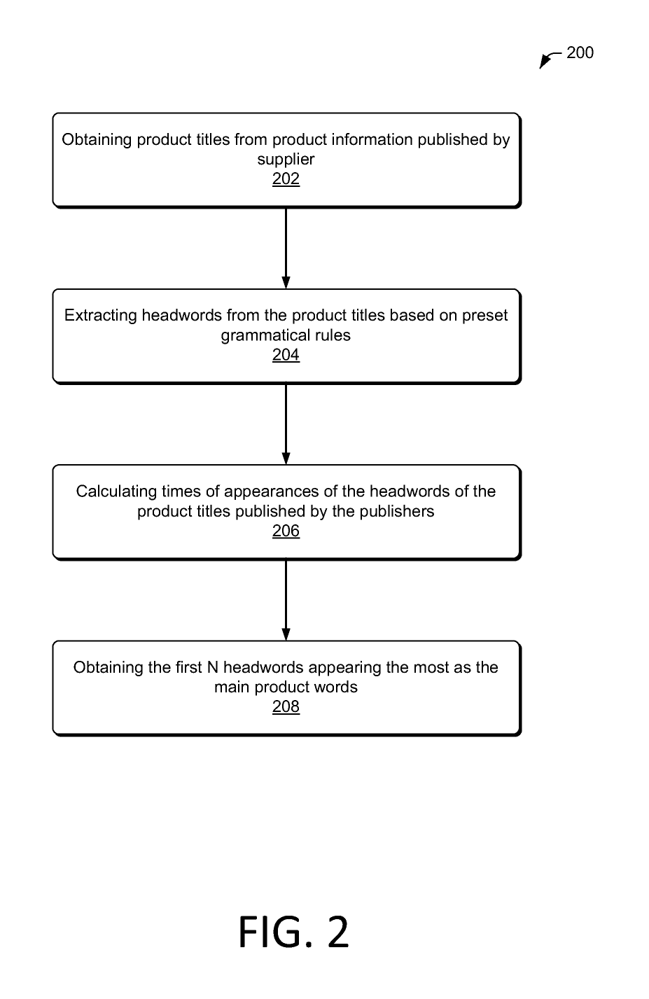

FIG. 2 is another exemplary process for obtaining main product words. In some embodiments, target word information is product titles, and the operation of extracting the first N headwords appearing the most in target information published by target users as target words may include obtaining product titles from the product information published by suppliers at 202. The suppliers may publish product information including the product titles, the manufacturers, the quantity of product, and etc. Therefore, the product titles may be obtained from the product information, such as the most popular chiffon dress.

At 204, the server may extract headwords from the product titles based on preset grammatical rules. The present disclosure presets some grammatical rules, and headwords may be extracted from the product titles based on the grammatical rules.

For example, if the product title is “adjective +noun”, the noun is the headword. For instance, the headword is “dress” if the product title is “the most popular chiffon dress”. If the product title is “noun +preposition”, the noun is the headword. For instance, the headword is “suit” if the product title is “suit for orders”. Different grammatical rules may be applied, and the embodiments here do not intend to limit the rules.

At 206, the server may calculate times of appearance of the headwords of all the product titles published by the publishers. Afterwards, times of appearance of each headword of all the product titles published by the publishers are calculated. For example, a user publishes 100 product titles, in which “dress” appears 20 times, “short skirt” appears 15 times, “short trousers” appears 30 times, “T-shirts” appears 22 times, and other accessories appear 3 times.

At 208, the server may obtain the first N headwords appearing the most as the main product words. In some embodiments, a threshold value N is set, and the first N headwords appearing the most may be obtained and used as the main product words. For example, the main products are short trousers, T-shirts and dresses if N is 3.

In some embodiments, for each headword, the server may calculate a ratio between the times of appearances of the headword and the times of appearances of all headwords and making the ratio as a main product factor of the headword. Accordingly, in the example described above, the main product factor of short trousers is 0.3, the main product factor of T-shirts is 0.22, and the main product factor of dresses is 0.3.

In some embodiments, the server may create an inverted index based on information on a page of suppliers and the main product words, wherein the inverted index includes a page information field and a main product field.

After receiving the inquiry phrase, the suppliers matching the inquiry phrase may be found in the inverted index. In some embodiments, a vague match may be performed in each field of the inverted index, and the inquiry phrase may include many single words. The suppliers matching any single word may be recognized as suppliers matching the inquiry phrase.

For example, if the inquiry phrase is “red apple”, a supplier is determined as one matching the inquiry phrase if the main product field of the supplier contains “apple”. For example, if a company name field of a page information field is “apple”, the supplier is also determined accordingly.

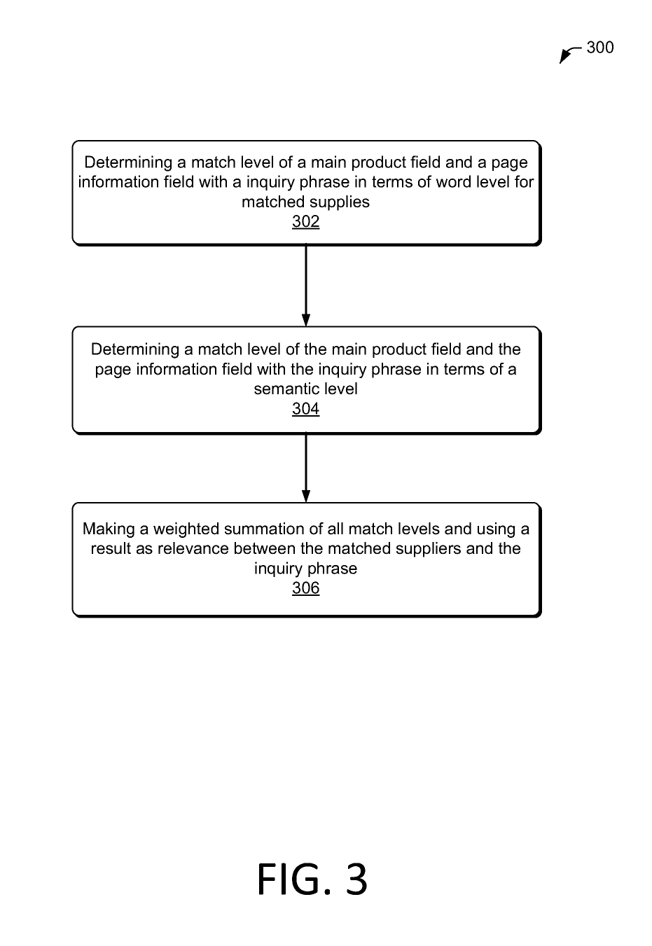

FIG. 3 is yet another exemplary process for determining a relevance. In some embodiments, the server may determine a relevance between the matched target users and the inquiry phrase through the target field and the page information field.

At 302, the server may determine a match level of a main product field and a page information field with an inquiry phrase in terms of word level for the matched suppliers. In these instances, for the matched suppliers, the server may determine a match level of the main product field with the inquiry phrase in terms of word level, and determine a match level of the page information field with the inquiry phrase in terms of word level.

For example, the match level in terms of word level may be determined based on the number of matched words and sliding windows, etc. If x consecutive words may cover the inquiry phrase thoroughly, the x is the number of sliding windows. In these instances, the number of words of the inquiry phrase is m, wherein x is not less than m, as well as x and m are both integers. For example, the inquiry phrase is “red apple”, and the main product field of the company is “red fuji apple”, then the number of sliding windows is 3.

At 304, the server may determine a match level of the main product field and the page information field with the inquiry phrase in terms of a semantic level. For the matched suppliers, the server may determine a match level of the main product field with the inquiry phrase in terms of a semantic level, and determine a match level of the page information field with the inquiry phrase in terms of a semantic level.

At 306, the server may make a weighted summation of all match levels and using a result as the relevance between the matched suppliers and the inquiry phrase. In some embodiments, the server may make a weighted summation of all matched levels and use a result as the relevance between the matched suppliers and the inquiry phrase.

For example, the server may adopt a linear regression model, and calculate the relevance score using the following equation.

relevanceScore=F(f₁, . . . , fₙ)

Here, F(f₁, . . . ,fₙ) indicates the model function of a linear regression model training, and fₙ indicates the value of the n^{th} feature. Each match may be the value of each feature.

Of course, there are different methods of calculating the relevance, such as using a human-marked relevance data, SVM (Support Vector Machine), a decision-tree, or other categorizer training models. The present embodiment does not intend to limit the method to the liner regression model.

In some embodiments, the server may pre-process the inquiry phrase before the operation of determining a relevance between the matched target users and the inquiry phrase through the target field and the page information field. The pre-processing includes at least one of the following steps. First, the server may delete invalid characters of the inquiry phrase, wherein certain invalid characters, such as unprintable characters, may be deleted. Second, the server may extract headwords from the inquiry phrase based on preset grammatical rules. For example, the inquiry phrase is “red apple”, and the noun “apple” may be obtained as the headword by removing the adjective “red”. Furthermore, the server may delete the word root of the inquiry phrase. In these instances, the singular and plural indications of the inquiry phrase may be deleted. For example, for “apples”, the result is “apple” after deleting the plural indication. Also, the server may identify national geography information of the inquiry phrase. Embodiments of the present disclosure may also preset a nation list for identifying the national geography information of the inquiry phrase. For example, the inquiry phrase is “Thailand rice,” and the national geography information is “Thailand”.

In some embodiments, before the operation of creating an inverted index based on information on a page of the target users and the target words, the server may delete invalid characters of information on the page, and/or delete word root information on the page.

Embodiments of the present disclosure pre-process information on the page of suppliers. The server may delete invalid characters of information on the page, such as unprintable characters, or delete the word root including the singular and plural indication of information on the page. It should be noted that these pre-processes may be performed at the same time or separately. The present disclosure has not limitation in this regard.

In some embodiments, the server may extract the page information field from the preprocessed page, wherein the page information field includes at least one of the following: a main product field, a nation field, a company address field and/or a company name field.

In some embodiments, the operation of determining a match level of the main product field and the page information field with the inquiry phrase in terms of word level may include calculating a corresponding match level when the page information field is determined to match the inquiry phrase in terms of word level. In some embodiments, the server may obtain the field value of the page information field of each inquiry target, and match with the inquiry phrase in terms of word level, and calculate the match level.

In some instances, the match level of the inquiry phrase with the field value of the company name field in terms of word level includes the number of matched words, sliding windows, and/or whether it's completely matched.

In some instances, the match level of the inquiry phrase with the field value of the company address field in terms of word level may include the number of matched words, sliding windows, and/or whether it's completely matched.

In some instances, the server may determine whether the national geography information of the inquiry phrase matches the field value of the national field. If so, the match level is 1. If not, the match level is 0. For example, the inquiry phrase is “Thailand rice,” and the national geography information identified from the pre-process of inquiry phrase is “Thailand”. If the field value of the national field is “Thailand”, the match level is 1.

In some instances, the match level of the inquiry phrase with the field value of the main product field in terms of word level includes determining whether the inquiry phrase matches the field value of the main product field. If so, the match level is 1. If not, the match level is 0.

In some embodiments, when the main product field is determined to match the inquiry phrase in terms of word level, the server may calculate a corresponding match level through the main product factor.

In some embodiments, the server may determine the match level of the inquiry phrase associated with the field value of the main product field in terms of word level. In these instances, the server may determine whether the inquiry phrase matches the field value of the main product field. If not, the match level is 0. If so, the server may calculate a match level based on the main product factor of the main product word corresponding to the field value.

In some embodiments, the operation of determining a match level of the main product field and the page information field with the inquiry phrase in terms of semantic level may include calculating a corresponding match level when the page information field is determined to match headwords of the inquiry phrase in terms of semantic level.

The match level of the inquiry phrase with the field value of the main product field in terms of semantic level includes whether the headwords of the inquiry phrase matches the field value of the main product field. If it matches, the match level is 1. If it does not, the match level is 0.

In some embodiments, when the main product field is determined to match headwords of the inquiry phrase in terms of semantic level, the server may calculate a corresponding match level through the main product factor.

In some embodiments, the server may determine the match level of the inquiry phrase associated with the field value of the main product field in terms of semantic level. In these instances, the server may determine whether the headwords of the inquiry phrase matches the field value of the main product field. If they don't match, the match level is 0. If they match, the server may calculate a match level based on the main product factor of the main product word corresponding to the field value.

The present disclosure may be applied to the e-commerce industry by making suppliers as the target users, making product information as the target information, and making main product words as the target words. Not only may the information be obtained from the suppliers' pages, but also the main product words may be obtained from the product information published by suppliers. The product information published by suppliers may thoroughly cover suppliers' product and may be timely updated. Therefore, the present disclosure obtains the main product words from the product information published by suppliers and reduce the meaningless product information of target users. Thus, the search accuracy based on the relevance of the main products is higher. As such, while providing an accurate and thorough search result, the high search efficiency is maintained and a waste of resource is avoided.

Furthermore, the present disclosure may pre-process the information of pages and the inquiry phrase by deleting invalid characters, word roots, and etc. This may speed up the search, find the sorting processes and result in the more accurate calculation of relevance.

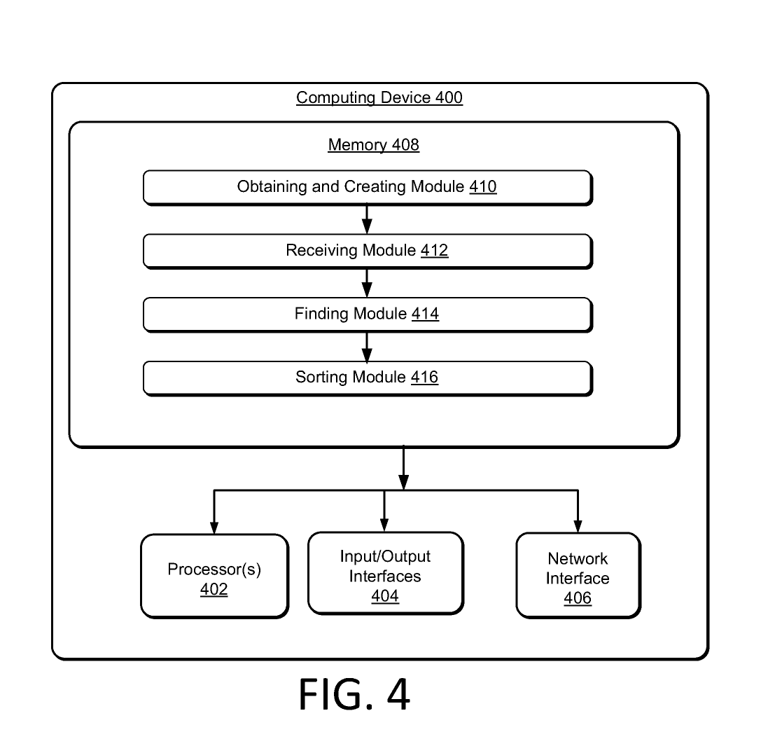

FIG. 4 is a diagram of a search device. FIG. 1 illustrates an example of a computing device 400. The computing device 400 may be a user device or a server for a multiple location login control. In one exemplary configuration, the computing device 400 includes one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include an obtaining and creating module 410, a receiving module 412, a finding module 414, and a sorting module 416.

The obtaining and creating module 410 is configured to extract the first N headwords appearing the most in target information published by target users as target words, and to create an inverted index based on information on a page of the target users and the target words, wherein the inverted index includes a target field and a page information field, and N is an integer. The receiving module 412 is configured to receive an inquiry phrase. The finding module 414 is configured to find target users matching the inquiry phrase in the inverted index based on the inquiry phrase. The sorting module 416 is configured to determine a relevance between the matched target users and the inquiry phrase through the target field and the page information field, and to sort the target users based on the relevance and returning.

In some embodiments, the obtaining and creating module 410 may include a first obtaining sub-module, an extraction sub-module, a statistic sub-module, a second obtaining sub-module.

The first obtaining sub-module is configured to obtain target word databases from the target information published by target users. The extraction sub-module is configured to extract headwords from the target word databases based on preset conditions. The statistic sub-module is configured to calculate times of appearance of the headwords of all target word databases published by the target users. The second obtaining sub-module is configured to obtain the first N headwords appearing the most as the target words.

In some embodiments, the obtaining and creating module 410 further includes a determining target factor sub-module configured to calculate a ratio of the times of appearances of the headword to the times of appearances of all headwords for each headword, and to make the ratio as a target factor of the headword.

In some embodiments, the sorting module 416 may include a match level determination sub-module configured to the matched target users, and to determine a match level of the target field and the page information field with the inquiry phrase. The sorting module 416 may also include a relevance calculation sub-module configured to make a weighted summation of all match levels, and to use a result as the relevance between the matched target users and the inquiry phrase.

In some embodiments, the target users may be suppliers, the target information may be product information, and the target words may be main product words.

In some embodiments, the target word information is product titles, and the obtaining and creating module 410 may include a first obtaining sub-module, an extraction sub-module, a statistic sub-module, a second obtaining sub-module, and a determining target factor sub-module.

The first obtaining sub-module is configured to obtain product titles from the product information published by suppliers. The extraction sub-module is configured to extract headwords from the product titles based on preset grammatical rules. The statistic sub-module is configured to calculate times of appearance of the headwords of all the product titles published by the publishers. The second obtaining sub-module is configured to obtain the first N headwords appearing most as the main product words. The determining target factor sub-module is configured to each headword, calculating a ratio of the times of appearances of the headword to the times of appearances of all headwords and making the ratio as a main product factor of the headword.

In some embodiments, the target field is a main product field, and the sorting module 416 may include a first match level determination sub-module, a second match level determination sub-module, and a relevance calculation sub-module.

The first match level determination sub-module is configured to determine a match level of the main product field and the page information field with the inquiry phrase in terms of a word level for the matched suppliers. The second match level determination sub-module is configured to determine a match level of the main product field and the page information field with the inquiry phrase in terms of a semantic level. The relevance calculation sub-module is configured to make a weighted summation of all match levels, and to use a result as the relevance between the matched suppliers and the inquiry phrase.

In some embodiments, the device may further include an inquiry phrase pre-process module, a page information pre-process module, and an extraction module. The inquiry phrase pre-process module is configured to pre-process the inquiry phrase. The pre-processing may include at least one of the following operations: deleting invalid characters of the inquiry phrase, extracting headwords from the inquiry phrase based on preset grammatical rules, deleting word root of the inquiry phrase, and/or identifying national geography information of the inquiry phrase.

The page information pre-process module is configured to pre-process information on a page of the suppliers by deleting invalid characters of information on the page, and/or deleting word root of information on the page.

The extraction module is configured to extract the page information field from the preprocessed page, wherein the page information field includes at least one of main product field, nation field, company address field, and/or company name field.

In some embodiments, the first match level determination sub-module may include a page information calculation unit configured to calculate a corresponding match level when the page information field is determined to match the inquiry phrase in terms of word level. The first match level determination sub-module may include a main product calculation unit configured to calculate a corresponding match level through the main product factor when the main product field is determined to match the inquiry phrase in terms of word level.

In some embodiments, the second match level determination sub-module may include a page information calculation unit and a main product calculation unit. The page information calculation unit is configured to calculate a corresponding match level when the page information field is determined to match headwords of the inquiry phrase in terms of semantic level. The main product calculation unit is configured to calculate a corresponding match level through the main product factor when the main product field is determined to match headwords of the inquiry phrase in terms of a semantic level.

As system embodiment shares the similar principles of method embodiments described above, the description is not discussed in a great detail. For details, the method embodiments may be referred to.

Persons skilled in the art should understand that the embodiments of the present disclosure may be methods, systems, or programming products of computers. Therefore, embodiments of the present disclosure may be implemented by hardware, software, or in combination of both. In addition, the present disclosure may be in a form of one or more computer programs containing the computer-executable codes which may be implemented in the computer-executable storage medium (including but not limited to disks, CD-ROM, optical disks, etc.).

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram may be implemented by computer program instructions. These computer program instructions may be provided to the general computers, specific computers, embedded processor or other programmable data processors to generate a machine, so that a device of implementing one or more flows of the flow chart and/or one or more blocks of the block diagram may be generated through the instructions operated by a computer or other programmable data processors.

These computer program instructions may also be saved in other computer-readable storage, which may instruct a computer or other programmable data processors to operate in a certain way, so that the instructions saved in the computer-readable storage generate a product containing the instruction device, wherein the instruction device implements the functions specified in one or more flows of the flow chart and/or one or more blocks of the block diagram.

These computer program instructions may also be loaded in a computer or other programmable data processors, so that the computer or other programmable data processors may operate a series of operation steps to generate the process implemented by a computer. Accordingly, the instructions operated in the computer or other programmable data processors may provides the steps for implementing the functions specified in one or more flows of the flow chart and/or one or more blocks of the block diagram.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A computer-implemented method for searching, the method comprising:
extracting, by a server, multiple keywords to generate target words, the multiple keywords being determined based on occurrences of the multiple keywords in target information published by multiple target users;
creating an inverted index based on the target words and page information of the multiple target users, the inverted index including a target field and a page information field;
receiving a query including a phrase;
finding one or more target users of the multiple target users in the inverted index using the phrase;
determining relevance between the one or more target users and the phrase based on one or more corresponding target fields and page information fields in the inverted index; and
sorting the one or more target users according to the relevance.

2. The computer-implemented method of claim 1, wherein numbers of the occurrences of the multiple keywords are greater than numbers of occurrences of other keywords in the target information.

3. The computer-implemented method of claim 1, wherein the extracting the multiple keywords to generate the target words comprises:
obtaining target word databases from the target information published by the multiple target users;
extracting keywords from the target word databases based on a preset condition;
calculating numbers of occurrences of the keywords; and
extracting the multiple keywords from the keywords.

4. The computer-implemented method of claim 3, further comprising:
calculating a ratio between occurrences a keyword and accumulated occurrences of the keywords; and
assigning the ratio as a target factor of the keyword.

5. The computer-implemented method of claim 1, wherein the determining the relevance comprising determining the relevance by:
determining a matching level based on a target field and a page information field; and
making a weighted summation of match levels associated with the one or more corresponding target fields and the page information fields in the inverted index.

6. The computer-implemented method as recited claim 1, wherein the multiple target users include suppliers of an item, the target information including information about the item, the target words include main product words.

7. The computer-implemented method of claim 1, wherein the target information is product titles, and the extracting the multiple keywords to generate the target words comprises:
obtaining product titles from the product information published;
extracting the keywords from the product titles based on a preset grammatical rule;
calculating occurrences of the keywords in the product titles; and
obtaining the multiple keywords from the keywords based on the occurrences to generate the target words.

8. The computer-implemented method of claim 7, wherein the target field includes a main product field, the multiple target users include suppliers of an item, and the determining the relevance between the one or more target users and the phrase comprises:
determining a matching level of the main product field and the page information field with the phrase in terms of word level;
determining a matching level of the main product field and the page information field with the phrase in terms of semantic level; and
determining the relevance between the suppliers and the phrase by making a weighted summation of match levels.

9. The computer-implemented method of claim 1, further comprising pre-processing the phrase, and the pre-processing comprises at least one of:
deleting invalid characters of the phrase;
extracting a plurality of keywords from the phrase based on preset grammatical rules;
deleting a word root of the phrase; or
identifying a national geography information of the phrase.

10. The computer-implemented method of claim 1, further comprising:
pre-processing information pages by deleting invalid characters from information on the page, or deleting one word root from the information on the page.

11. The computer-implemented method of claim 10, further comprising:
extracting the page information field from the pre-processed page, wherein the page information field comprises at least one of a main product field, a nation field, a company address field, or a company name field.

12. The computer-implemented method of claim 11, further comprising:
calculating a corresponding matching level when the page information field is determined to match the phrase in terms of a word level; and
calculating a corresponding match level through a main product factor when the main product field is determined to match the phrase in terms of the word level.

13. The computer-implemented method of claim 11, further comprising:
calculating a corresponding match level when the page information field is determined to match keywords of the phrase in terms of a semantic level; and
calculating a corresponding match level through a main product factor when the main product field is determined to match keywords of the phrase in terms of the semantic level.

14. A system comprising:
one or more processors; and
memory to maintain a plurality of components executable by the one or more processors, the plurality of components comprising:
an obtaining and creating module configured to:
extract, by a server, multiple keywords to generate target words, the multiple keywords being determined based on occurrences of the multiple keywords in target information published by multiple target users, and
create an inverted index based on the target words and page information of the multiple target users, the inverted index including a target field and a page information field,
a receiving module configured to receive an phrase,
a finding module configured to find one or more target users of the multiple target users in the inverted index using the phrase, and
a sorting module configured to:
determine relevance between the one or more target users and the phrase based on one or more corresponding target fields and page information fields in the inverted index; and
sort the one or more target users according to the relevance.

15. The system of claim 14, wherein numbers of the occurrences of the multiple keywords are greater than numbers of occurrences of other keywords in the target information.

16. The system of claim 14, wherein the extracting the multiple keywords to generate the target words comprises:
obtaining target word databases from the target information published by the multiple target users;
extracting keywords from the target word databases based on a preset condition;
calculating numbers of occurrences of the keywords; and
extracting the multiple keywords from the keywords.

17. The system of claim 14, wherein the sorting module is configured to further:
calculate a ratio between occurrences a keyword and accumulated occurrences of the keywords; and
assign the ratio as a target factor of the keyword.

18. One or more computer-readable media storing computer-executable instructions that, when executed by one or more processors, instruct the one or more processors to perform acts comprising:
receiving a query including a phrase;
determining one or more users in the inverted index using the phrase, wherein the inverted index is created by:
extracting multiple keywords from messages based on occurrences of the multiple keywords, the messages being published by multiple users in a community;
creating an inverted index based on the multiple keywords and information provided by the multiple users in web pages associated with the multiple users;
determining relevant parameters between the one or more users and the phrase based on corresponding information in the inverted index; and
sorting the one or more users based on the relevant parameters.

19. The one or more computer-readable media of claim 18, wherein numbers of the occurrences of the multiple keywords are greater than numbers of occurrences of other keywords in the messages.

20. The one or more computer-readable media of claim 18, where the acts further comprise pre-processing the phrase by:
deleting invalid characters of the phrase;
extracting a plurality of keywords from the phrase based on preset grammatical rules;
deleting a word root of the phrase; and
identifying a national geography information of the phrase, and the determining the one or more users of the multiple users in the inverted index using the phrase comprises determining the one or more users of the multiple users in the inverted index based on the pre-processed phrase.
